(19) United States
(12) Patent Application Publication
(10) Pub. No.: US 2005/0157203 A1
(43) Pub. Date: Jul. 21, 2005

(54) Flicker detecting device and image pickup apparatus

(75) Inventors: Toshio Nakakuki, Mizuho-shi (JP); Ritsuya Iida, Anpachi-gun (JP)

Correspondence Address: OLIFF & BERRIDGE, PLC, P.O. BOX 19928, ALEXANDRIA, VA, 22320, US

(73) Assignee: SANYO ELECTRIC CO., LTD., Moriguchi-shi (JP)

(21) Appl. No.: 11/011,447

(22) Filed: Dec. 15, 2004

(30) Foreign Application Priority Data
Dec. 19, 2003 (JP) 2003-421901

(51) Int. Cl. H04N 5/235; H04N 5/222; H04N 5/335; H04N 3/14; G03B 7/00

(52) U.S. Cl. 348/362; 348/370

(57) ABSTRACT

Flicker, which occurs in photographing of a moving image under lighting by a fluorescent lamp, is detected accurately. A common multiple of a light-emitting period 1/100 sec in a region where a frequency of a commercial AC power supply is 50 Hz, a light-emitting period 1/120 sec in a region where the frequency is 60 Hz, and 1/fp according to a frame rate fp is defined as a synchronous period. An exposure condition determining unit decides an exposure condition on the basis of an image signal level at each synchronous period and feeds back the exposure condition to exposure control of a frame after the synchronous period. A synchronous level extracting unit extracts image signal levels for plural frames at each synchronous period and a synchronous judging unit judges a stability state of the levels. On the other hand, a flicker judging unit detects presence of a section where a fluctuation in an image signal level between adjacent frames is large in the synchronous period. When the synchronous level judging unit confirms that an exposure stable state is realized, the flicker judging unit makes a result of judgment on flicker based on the fluctuation of a signal level in the synchronous period effective.

### CROSS-REFERENCE TO RELATED APPLICATIONS

The priority application Number JP2003-421901 upon which this patent application is based is hereby incorporated by reference.

### FIELD OF THE INVENTION

The present invention relates to a flicker detecting device that detects flicker that occurs when a moving image is photographed under a light source such as a fluorescent lamp, brightness of which changes periodically, and an image pickup apparatus using the flicker detecting device.

### BACKGROUND OF THE INVENTION

Many cellular phones in recent years are mounted with a solid-state image pickup device such as a CCD image sensor and have a camera function in addition to a function as a cellular phone. A cellular phone can send a photographed image to a terminal such as another cellular phone. At present, the improvement of a transmission technology makes it possible to deliver not only still images but also moving images.

When a moving image is photographed under a light source periodically emitting light, flicker, which is a phenomenon in which a level of an image signal fluctuates for each image, may occur due to a difference between a light-emitting period of the light source and an image pickup period. FIG. 1 is a schematic timing chart explaining a case in which an image of a subject lighted by a fluorescent lamp, which emits light with an AC power supply of 50 Hz, is picked up at a frame rate of 15 fps in an image pickup apparatus using a frame transfer type CCD image sensor. The figure shows a light-emitting intensity L of the light source, a vertical synchronizing signal VD, and a timing pulse ST of an electronic shutter. An exposure period E is a period from timing when information charges accumulated in an image pickup portion of the CCD image sensor are discharged once by an electronic shutter operation until timing when frame transfer associated with the VD is started. In this example, whereas a fluctuation period T1 of the light-emitting intensity L of the light source is 1/100 sec, an image pickup period T2 is 1/15 sec. Phases of the light emission and the image pickup operation coincide with each other only at a period of ⅕ sec that is a common multiple of the periods T1 and T2. In other words, exposure in photographing of three frames during the period of ⅕ sec is performed at timings different from each other in the light-emitting period. Since a level of an image signal is proportional to an integral value of the light-emitting intensity L of the light source at an exposure period E during each image pickup operation, flicker could occur due to a difference of positions of the exposure period E during the light-emitting period of the light source. Such flicker is more conspicuous as the exposure period E is shorter.

Conventionally, a peak position of an integral value of a luminance signal for each image is detected, and detection of the flicker, which occurs at the time of image pickup, is performed on the basis of presence or absence of periodicity of the peak position and a frequency of the peak position. In addition, conventionally, a technique for preventing flicker from occurring when the flicker is detected has been proposed. For example, JP-A-2000-224491 discloses a technique for continuously operating a solid-state image pickup device without causing flicker even when a frame rate does not coincide with a light-emitting period of a light source as in the example described above.

In the world, there are regions where a frequency of a commercial AC power supply is 50 Hz and regions where the frequency is 60 Hz. In Japan, the eastern Japan is the 50 Hz region and the western Japan is the 60 Hz region. Thus, according to the conventional technique, for example, when an image pickup apparatus detects occurrence of a periodical peak of an image signal level in a state in which the image pickup apparatus is driven to control flicker in one of the regions, it is possible to switch the image pickup apparatus to be driven to control flicker in the other region. In addition, in the method of detecting flicker on the basis of a fluctuating frequency of an image signal level, an image pickup apparatus can estimate whether a region is the 50 Hz region or the 60 Hz region from the fluctuating frequency and an image pickup period at a point of the fluctuating frequency. It is possible to change a way of driving the image pickup apparatus according to a result of the estimation such that flicker does not occur.

Conventionally, flicker is detected on the basis of the periodic fluctuation in an image signal level. However, the image signal level also fluctuates due to factors other than the periodic light emission of the light source. The fluctuation due to the other factors may be detected as flicker by mistake or may disturb flicker to cause misdetection of a flicker frequency or omission of detection of flicker. For example, usually, automatic exposure control (auto-iris control), which is usually performed in an image pickup apparatus, could be one of the other factors. In the automatic exposure control, for the purpose of keeping an image signal level at a predetermined target level, feedback control concerning exposure conditions is performed. For example, when an image signal level of a certain frame exceeds the target level, the exposure period E of following frames is set shorter than the present state (this is represented as “stop an iris”) and, on the other hand, when an image signal level is below the target level, the exposure period E is set longer than the present state (this is represented as “open an iris”). A time constant of feedback is set short such that it is possible to promptly follow a change in brightness of a subject. Here, in general, in a CCD image sensor, information charges accumulated in an exposure period of a certain frame are transferred to a storage portion or the like once, and an operation for reading out the information charges is performed in parallel with an accumulating operation for information charges of the next frame. Therefore, an exposure condition, which is obtained on the basis of image pickup in a certain frame, is fed back to exposure two frames after the frame.

FIGS. 2 and 3 are schematic diagrams showing examples of a signal level for each image at the time when a temporally fixed subject is photographed at 15 fps under a fluorescent lamp that emits light with a 50 Hz power supply, respectively. FIG. 2 shows a case in which exposure control is not performed, and FIG. 3 shows a case in which automatic exposure control at a two frame period is performed. In the figures, a rightward direction corresponds to a time axis, signs “a₁”, “b₁”, “c₁”, and the like written above respective rectangles indicate that frames corresponding to the signs are frames A, B and C in FIG. 1, and signs such as α, β, and γ in the rectangles indicate image signal levels of the frames. In the case in which the exposure control is not performed as shown in FIG. 2, that is, in the case in which the exposure time E is fixed, basically, α, β, and γ are repeated as the image signal levels. In other words, the image signal level fluctuates at a three frame period, and it is possible to detect flicker on the basis of the image signal level and estimate a light-emitting period. Next, the case of FIG. 3 will be explained. In this example, P is a proper exposure level, a relation among the image signal levels are set as α>β>γ, and a level change according to the exposure control is simplified in order to further simplify an explanation. The image signal level a of the frame “a₁” that is photographed with the exposure time E set to an initial value “e” is higher than the proper exposure level, that is, the frame “a₁” is photographed at brightness higher than the proper exposure level. Thus, an exposure control circuit sets an exposure time to e-, which is shorter than e, in the frame “c₁” two frames after the frame “a₁” (stop an iris). As a result, image signal levels of the frame “c₁” and “a₂” are γ- and α-lower than γ and α, respectively. The exposure control circuit detects that the image signal level γ- of the frame “c₁” is lower than the proper exposure level, that is, the frame “c₁” is photographed at brightness lower than the proper exposure level and returns the exposure time from e- to e in the frame “b₂” two frames after the frame “c₁” (open an iris). As a result, image signal levels of the frames “b₂” and “c₂” are β and γ, respectively. Subsequently, the exposure control circuit detects that the image signal level of the frame “b₂” is the proper exposure level β and maintains the exposure time at e in the frame “a₃” two frames after the frame “b₂”. As a result, image signal levels of the frames “a₃” and “b₃” are α and β, respectively. After the frame “a₃”, the exposure states of the frames “a₁” to “c₂” are repeated. As a result, the fluctuation in the image signal level reaches a peak in the frames “a₁”, “a₃”, “a₅”, and the like.

In this way, when the automatic exposure control is performed simply, a peak position and a fluctuation period of the image signal level could be different from those peculiar to flicker. Therefore, as already mentioned, there is a problem in that a flicker frequency is detected by mistake or it is judged that a fluctuation in an image signal level is not due to flicker to cause omission of detection of flicker.

An image signal level changes according to a subject even if brightness of a light source is fixed. Under a situation in which an image signal level could fluctuate due to a subject, it is not easy to judge whether the fluctuation in the image signal level is due to flicker. In addition, even in photographing under a light source, brightness of which fluctuates periodically, a peak position and a fluctuation period of an image signal level could be different from those peculiar to flicker under influence of change in a subject, as in the case of the automatic exposure control, there is a problem in that accuracy of detection of flicker falls.

### SUMMARY OF THE INVENTION

The invention has been devised in order to solve the problems, and it is an object of the invention to provide a flicker detecting device that accurately detects flicker that occurs when a moving image is photographed under a light source such as a fluorescent lamp, brightness of which changes periodically, and an image pickup apparatus using the flicker detecting device.

A flicker detecting device in accordance with an aspect of the invention is a flicker detecting device that is used in an image pickup apparatus for photographing an image at a frame rate fp and detects flicker of an image due to a light source, brightness of which changes periodically at a period of 1/f, the flicker detecting, device including: a synchronous level extracting unit that extracts a synchronous image signal level on the basis of the image photographed at each synchronous period that is a common multiple of 1/f and 1/fp; an exposure control unit that performs exposure control for maintaining photographing by the image pickup apparatus in a predetermined exposure state on the basis of the synchronous image signal level; and a flicker judging unit that detects a fluctuation in an image signal level in the synchronous period of the image and judges presence or absence of the flicker on the basis of the level fluctuation.

A flicker detecting device in accordance with still another aspect of the invention is a flicker detecting device that is used in an image pickup apparatus for photographing an image at a frame rate fp and detects flicker of an image due to a light source, brightness of which changes periodically at a period of 1/f, the flicker detecting device including: a synchronous level extracting unit that extracts a synchronous image signal level on the basis of the image photographed at each synchronous period that is a common multiple of 1/f and 1/fp; a synchronous level judging unit that judges whether the photographing by a synchronous level stable state, in which the synchronous image signal level is maintained within a predetermined range, is realized; and a flicker judging unit that detects a fluctuation in an image signal level in the synchronous period of the image and judges presence or absence of the flicker on the basis of the level fluctuation, wherein the flicker judging unit makes a result of the judgment on presence or absence of the flicker effective when the synchronous level stable state is realized.

An image pickup apparatus in accordance with an aspect of the invention is an image pickup apparatus for photographing an image at a frame rate fp that is capable of switching at least a drive state in which flicker of an image does not occur under a first light source, brightness of which changes periodically at a period of 1/f1, and a drive state in which flicker of an image does not occur under a second light source, brightness of which changes periodically at a period of 1/f2, the image pickup apparatus including: a synchronous level extracting unit that extracts a synchronous image signal level on the basis of the image photographed at each synchronous period that is a common multiple of 1/f1, 1/f2, and 1/fp; an exposure control unit that performs exposure control for maintaining the photographing by the image pickup apparatus in a predetermined exposure state on the basis of the synchronous image signal; a flicker judging unit that detects a fluctuation in an image signal level in the synchronous period of the image and judges presence or absence of the flicker on the basis of the level fluctuation; and a switching unit that switches the drive states according to a result of the judgment of the flicker judging unit.

An image pickup apparatus in accordance with still another aspect of the invention is an image pickup apparatus for photographing an image at a frame rate fp that is capable of switching at least a drive state in which flicker of an image does not occur under a first light source, brightness of which changes periodically at a period of 1/f1, and a drive state in which flicker of an image does not occur under a second light source, brightness of which changes periodically at a period of 1/f2, the image pickup apparatus including: a synchronous level extracting unit that extracts a synchronous image signal level on the basis of the image photographed at each synchronous period that is a common multiple of 1/f1, 1/f2, and 1/fp; a synchronous level judging unit that judges whether a synchronous level stable state, in which the synchronous image signal level is maintained within a predetermined range, is realized; a flicker judging unit that detects a fluctuation in an image signal level in the synchronous period of the image and judges presence or absence of the flicker on the basis of the level fluctuation; and a switching unit that switches the drive states according to a result of the judgment of the flicker judging unit, wherein the flicker judging unit makes a result of the judgment on presence or absence of the flicker effective when the synchronous level stable state is realized.

### BRIEF DESCRIPTION OF THE DRAWINGS

In the accompanying drawings:

FIG. 1 is a schematic timing chart explaining a case in which an image of a subject lighted by a fluorescent lamp, which emits light with an AC power supply of 50 Hz, is picked up at a frame rate of 15 fps in an image pickup apparatus using a CCD image sensor;

FIG. 2 is a schematic diagram showing an example of a signal level for each image at the time when the image is photographed at 15 fps without performing exposure control under the fluorescent lamp that emits light with the 50 Hz power supply;

FIG. 3 is a schematic diagram showing an example of a signal level for each image at the time when the image is photographed at 15 fps by performing automatic exposure control at a two frame period under the fluorescent lamp that emits light with the 50 Hz power supply;

FIG. 4 is a schematic block diagram of an image pickup apparatus in accordance with the invention;

FIG. 5 is a block diagram showing a schematic circuit structure of a flicker detection circuit that is an embodiment of the invention; and

FIG. 6 is a timing chart for explaining an operation of the flicker detection circuit that is an embodiment of the invention.

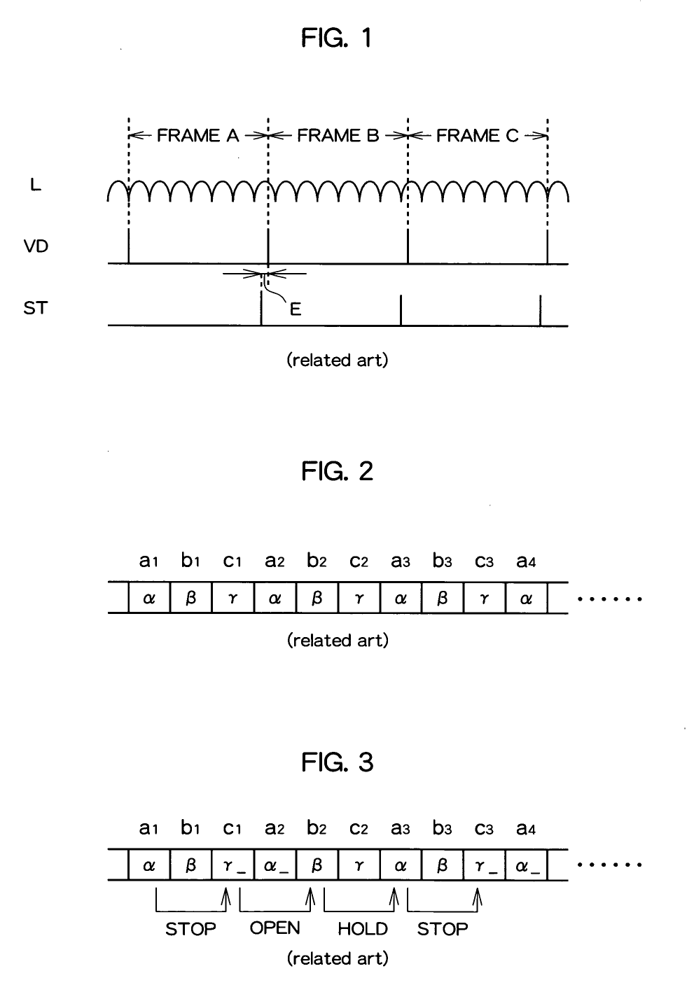

### DESCRIPTION OF THE PREFERRED EMBODIMENT

At the beginning, fundamental aspects of flicker detecting devices and image pickup apparatuses in accordance with the preferred embodiments of the invention will be hereinafter reviewed.

The first fundamental configuration of the flicker detecting device in accordance with the invention is a flicker detecting device that is used in an image pickup apparatus for photographing an image at a frame rate fp and detects flicker of an image due to a light source, brightness of which changes periodically at a period of 1/f, the flicker detecting device including: a synchronous level extracting unit that extracts a synchronous image signal level on the basis of the image photographed at each synchronous period that is a common multiple of 1/f and 1/fp; an exposure control unit that performs exposure control for maintaining photographing by the image pickup apparatus in a predetermined exposure state on the basis of the synchronous image signal level; and a flicker judging unit that detects a fluctuation in an image signal level in the synchronous period of the image and judges presence or absence of the flicker on the basis of the level fluctuation.

This flicker detecting device performs extraction of an image signal level and feedback control for an exposure state based on the image signal level in a fixed phase of a period of change in light emission of a light source. This exposure control is not affected by a periodical change of light emission of the light source and is capable of eliminating a fluctuation in an image signal level according to a subject. As a result, under a situation in which brightness of the light source changes periodically at a period of 1/f, basically, an image signal level at timing of each synchronous period, at which extraction of an exposure state is performed, is maintained near a target level of the exposure control. An image signal level, which is obtained at timing between the timings, has a value relatively apart from the target level. In other words, a fluctuation at each synchronous period corresponding to the period 1/f of the light emission of the light source appears suitably in the image signal level. It is possible to detect presence or absence of flicker due to the light source on the basis of the level fluctuation.

A flicker detecting device expanded the first fundamental configuration is a flicker detecting device that is used in an image pickup apparatus for photographing an image at a frame rate fp and detects flicker of an image due to a first light source, brightness of which changes periodically at a period of 1/f1, and flicker of an image due to a second light source, brightness of which changes periodically at a period of 1/f2, the flicker detecting device including: a synchronous level extracting unit that extracts a synchronous image signal level on the basis of the image photographed at each synchronous period that is a common multiple of 1/f1, 1/f2, and 1/fp; an exposure control unit that performs exposure control for maintaining photographing by the image pickup apparatus in a predetermined exposure state on the basis of the synchronous image signal level; and a flicker judging unit that detects a fluctuation in an image signal level in the synchronous period of the image and judges presence or absence of the flicker on the basis of the level fluctuation.

In this flicker detecting device, a synchronous period is defined to be a common multiple of different light-emitting periods of two light sources. Thus, under any one of the light sources, exposure control, which is performed on the basis of the synchronous period, is not affected by a periodical change in light emission of the light source and is capable of eliminating a fluctuation in an image signal level according to a subject. Thus, it is possible to perform flicker detection based on a fluctuation at each synchronous period of the image signal level accurately under any one of the light sources.

This flicker detecting device can further include a synchronous level judging unit that judges whether a synchronous level stable state, in which the synchronous image signal level is maintained within a predetermined range, is realized, wherein the flicker judging unit makes a result of the judgment on presence or absence of the flicker effective when the synchronous level stable state is realized. If the exposure control is performed in association with the synchronous period, basically, it is expected that an exposure stable state, in which the synchronous image signal level is maintained near the target level of the exposure control, is realized. However, it is likely that a sudden change in a subject, which the exposure control cannot follow, occurs and the exposure stable state is not realized. To deal with such case, in this flicker detecting device, it is confirmed whether the exposure stable state is realized on the basis of the synchronous image signal level and, when the exposure stable state is not realized, the result of the judgment on presence or absence of the flicker based on the fluctuation in the image signal level in the synchronous period is made ineffective to prevent wrong judgment from being made.

The second fundamental configuration of the flicker detecting device in accordance with the invention is a flicker detecting device that is used in an image pickup apparatus for photographing an image at a frame rate fp and detects flicker of an image due to a light source, brightness of which changes periodically at a period of 1/f, the flicker detecting device including: a synchronous level extracting unit that extracts a synchronous image signal level on the basis of the image photographed at each synchronous period that is a common multiple of 1/f and 1/fp; a synchronous level judging unit that judges whether the photographing by a synchronous level stable state, in which the synchronous image signal level is maintained within a predetermined range, is realized; and a flicker judging unit that detects a fluctuation in an image signal level in the synchronous period of the image and judges presence or absence of the flicker on the basis of the level fluctuation, wherein the flicker judging unit makes a result of the judgment on presence or absence of the flicker effective when the synchronous level stable state is realized.

Even when the exposure control is not performed, the exposure stable state could be realized when a subject does not change. The flicker detecting device confirms that the exposure stable state is realized on the basis of the synchronous image signal and, then, makes the result of the judgment on presence or absence of the flicker based on the fluctuation in the image signal level within the synchronous period effective to prevent wrong judgment on flicker that could occur when the exposure stable state is not realized.

A flicker detecting device expanded the second fundamental configuration is a flicker detecting device that is used in an image pickup apparatus for photographing an image at a frame rate fp and detects flicker of an image due to a first light source, brightness of which changes periodically at a period of 1/f1, and flicker of an image due to a second light source, brightness of which changes periodically at a period of 1/f2, the flicker detecting device including: a synchronous level extracting unit that extracts a synchronous image signal level on the basis of the image photographed at each synchronous period that is a common multiple of 1/f1, 1/f2, and 1/fp; a synchronous level judging unit that judges whether a synchronous level stable state, in which the synchronous image signal level is maintained within a predetermined range, is realized; and a flicker judging unit that detects a fluctuation in an image signal level in the synchronous period of the image and judges presence or absence of the flicker on the basis of the level fluctuation, wherein the flicker judging unit makes a result of the judgment on presence or absence of the flicker effective when the synchronous level stable state is realized.

In this flicker detecting device, a synchronous period is defined to be a common multiple of different light-emitting periods of two light sources, and the exposure stable state in the synchronous period is confirmed. Thus, under any one of the light sources, wrong judgment on flicker, which could occur when the exposure stable state is not realized, is prevented.

For example, the flicker judging unit may judge that the flicker has occurred when a degree of the fluctuation is larger than a predetermined reference value.

For example, the flicker judging unit may judge that the flicker has occurred when a degree of the fluctuation is larger than a predetermined reference value in each of a predetermined number of continuous synchronous periods. According to this configuration, the flicker detecting device judges flicker on the basis of coincidence of fluctuations in an image signal level in continuous plural synchronous periods. Consequently, a fluctuation in an image signal level due to a temporary cause such as accidental passage of some object in an image pickup area is prevented from being detected as flicker.

The first fundamental configuration of the image pickup apparatus in accordance with the invention is an image pickup apparatus for photographing an image at a frame rate fp that is capable of switching at least a drive state in which flicker of an image does not occur under a first light source, brightness of which changes periodically at a period of 1/f1, and a drive state in which flicker of an image does not occur under a second light source, brightness of which changes periodically at a period of 1/f2, the image pickup apparatus including: a synchronous level extracting unit that extracts a synchronous image signal level on the basis of the image photographed at each synchronous period that is a common multiple of 1/f1, 1/f2, and 1/fp; an exposure control unit that performs exposure control for maintaining the photographing by the image pickup apparatus in a predetermined exposure state on the basis of the synchronous image signal; a flicker judging unit that detects a fluctuation in an image signal level in the synchronous period of the image and judges presence or absence of the flicker on the basis of the level fluctuation; and a switching unit that switches the drive states according to a result of the judgment of the flicker judging unit.

This image pickup apparatus can include a synchronous level judging unit that judges whether a synchronous level stable state, in which the synchronous image signal level is maintained within a predetermined range, is realized, wherein the flicker judging unit makes a result of the judgment on presence or absence of the flicker effective when the synchronous level stable state is realized.

The second fundamental configuration of the image pickup apparatus in accordance with the invention is an image pickup apparatus for photographing an image at a frame rate fp that is capable of switching at least a drive state in which flicker of an image does not occur under a first light source, brightness of which changes periodically at a period of 1/f1, and a drive state in which flicker of an image does not occur under a second light source, brightness of which changes periodically at a period of 1/f2, the image pickup apparatus including: a synchronous level extracting unit that extracts a synchronous image signal level on the basis of the image photographed at each synchronous period that is a common multiple of 1/f1, 1/f2, and 1/fp; a synchronous level judging unit that judges whether a synchronous level stable state, in which the synchronous image signal level is maintained within a predetermined range, is realized; a flicker judging unit that detects a fluctuation in an image signal level in the synchronous period of the image and judges presence or absence of the flicker on the basis of the level fluctuation; and a switching unit that switches the drive states according to a result of the judgment of the flicker judging unit, wherein the flicker judging unit makes a result of the judgment on presence or absence of the flicker effective when the synchronous level stable state is realized.

For example, the switching unit may switch a present drive state to another drive state in which the flicker does not occur when the flicker is detected.

Hereinafter, fundamental aspects of flicker detecting devices and image pickup apparatuses in accordance with the preferred embodiments of the invention are reviewed.

The details of the preferred embodiment will be hereinafter explained with reference to the accompanying drawings.

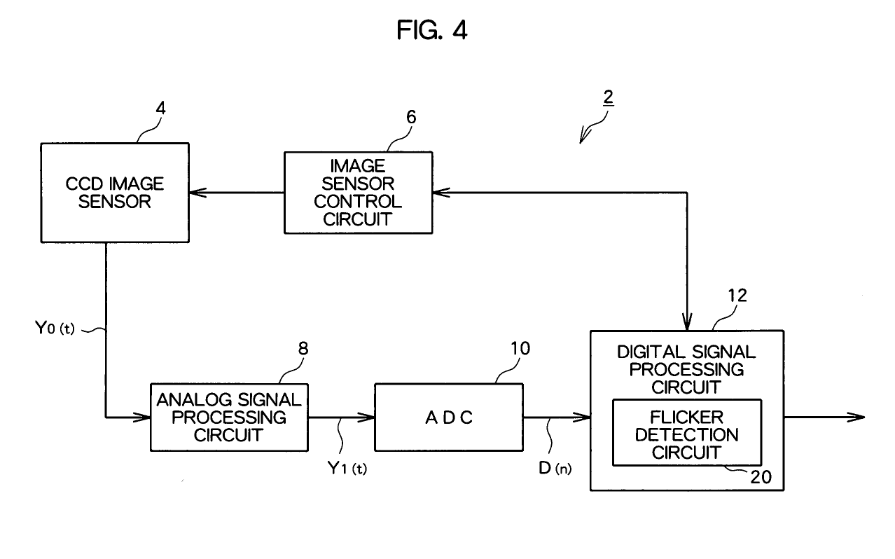

FIG. 4 is a schematic block diagram of an image pickup apparatus in accordance with the invention. An image pickup apparatus 2 includes a CCD image sensor 4, an image sensor control circuit 6, an analog signal processing circuit 8, an analog-to-digital converter (ADC) 10, and a digital signal processing circuit 12 and can photograph a moving image.

For example, when the CCD image sensor 4 is a frame transfer type, the image sensor control circuit 6 includes a driver for driving an image pickup portion, a accumulation unit, a horizontal transfer portion, an output portion, and a substrate potential of the CCD image sensor 4 and a timing control circuit for performing timing control for an output pulse of the driver. More specifically, the image sensor control circuit 6 performs, for example, frame transfer for transferring information charges at high speed from the image pickup portion to the accumulation unit, line feed transfer for transferring the information charges for one horizontal line at a time from the accumulation unit to the horizontal transfer portion, and horizontal transfer for sequentially transferring the information charges, which are transferred to the horizontal transfer portion, to the output portion.

Here, the image sensor control circuit 6 can adjust a frame interval of moving image photographing according to whether a region of use is a region where a frequency of AC power supply is 50 Hz or a region where the frequency is 60 Hz and control flicker under a light source like a fluorescent lamp, brightness of which changes periodically according to a power supply period. For example, it is possible to automatically perform switching for setting the frame interval to a frame interval suitable for the region of 50 Hz or 60 Hz on the basis of a result of judgment on presence or absence of flicker in the digital signal processing circuit 12 to be described later. This flicker control will be further explained later.

In addition, the image sensor control circuit 6 performs auto-iris control for controlling an electronic shutter operation in the image pickup portion on the basis of exposure information generated in the digital signal processing circuit 12 to adjust exposure time. For example, the image sensor control circuit 6 has a shutter timing register (ST register) for storing a numerical value corresponding to a time from timing of a vertical synchronizing pulse VD to timing of a trigger pulse of the electronic shutter. The numerical value is changed by the digital signal processing circuit 12 according to a signal level of an image signal outputted from the CCD image sensor 4. The image sensor control circuit 6 measures a time from the timing of the VD using a counter and, when a value of the counter coincides with a set value of the ST register, generates a shutter trigger pulse to discharge the information charges accumulated in the image pickup portion. For example, when an image signal level exceeds a target range that is a proper exposure level, the image sensor control circuit 6 increases a value of the ST register to thereby delay shutter trigger in later photographing and shorten an accumulation time of the information charges. On the contrary, when the image signal level is lower than the target range, the image sensor control circuit 6 reduces the value of the ST register to thereby bring forward the shutter trigger and lengthen the accumulation time. Consequently, the accumulation time is subjected to feedback control such that the image signal level is kept at a proper level regardless of a luminance of a subject.

The analog signal processing circuit 8 applies processing such as correlated double sampling (CDS) and automatic gain control (AGC) to an image signal Y0(t) outputted from the CCD image senor 4 and outputs an image signal Y1(t) subjected to waveform shaping. The ADC 10 converts this image signal Y1(t) into a digital signal pixel by pixel to generate image data D(n).

The digital signal processing circuit 12 applies processing such as color separation, matrix calculation, and white balanced adjustment to image data D(n) to generate luminance data Y(n) and color difference data U(n) and V(n). The digital signal processing circuit 12 may further process the data Y(n), U (n), and V(n). The digital signal processing circuit 12 can also output the generated data to a display unit or a recording unit to use the data for screen display or store the data in a recording medium. In addition, the digital signal processing circuit 12 integrates the image signal outputted from the CCD image sensor 4 by an amount equivalent to one screen or an amount equivalent to an arbitrary area in one screen to calculate an image signal level. As described above, this image signal level is used for the auto-iris control in the image sensor control circuit 6. The digital signal processing circuit 12 also includes a flicker detection circuit 20. The flicker detection circuit 20 judges presence or absence of flicker on the basis of a fluctuation in the image signal level. A result of the judgment is used in the image sensor control circuit 6 as described above.

The image sensor control circuit 6 controls flicker with a photographing operation proposed in, for example, JP-A-2000-224491 described above. Here, flicker-less drive of the image sensor control circuit 6 will be explained briefly with a case in which the image pickup apparatus photographs a moving image at a frame rate of 15 fps as an example. A fluorescent lamp blinks at a period of 1/100 sec in the 50 Hz region and blinks at a period of 1/120 sec in the 60 Hz region. Light emission timing of the fluorescent lamp and photographing timing synchronize with each other at a common multiple period of periods thereof. Here, a common multiple period T of plural periods τ_{ξ}(ξ=1, 2, . . . , m) means a time length in which a natural number c_{ξ}, which satisfies a condition T=c_{ξ}τ_{ξ} for an arbitrary ξ, is present. In other words, light emission of the fluorescent lamp and photographing in each of the 50 Hz region and the 60 Hz region synchronize with each other at a ⅕ sec period, which is a common multiple of three periods 1/100 sec, 1/120 sec, and 1/15 sec. Photographing of three frames is performed in both the regions within this synchronous period.

Light emission of 20 cycles is performed during ⅕ sec in the 50 Hz region. Thus, of this 20 cycles, if timings, which are in an identical phase and at approximately equal intervals, are set as photographing timings for the three frames, it is possible to control flicker in the 50 Hz region. For example, the image sensor control circuit 6 divides 20 cycles into 7 cycles, 7 cycles, and 6 cycles as an operation mode in which flicker does not occur in photographing under light emission of a fluorescent lamp in the 50 Hz region (50 Hz region operation mode) and controls the CCD image sensor 4 to perform photographing of three frames at these periods.

On the other hand, in the 60 Hz region, a common multiple of periods of light emission and photographing at 15 fps in the region is 1/15 sec. This means that, in the 60 Hz region, if photographing timings of the respective frames are set to equal interval periods, photographing is performed in a fixed phase of the period of the light emission, which makes it possible to control flicker. In other words, as an operation mode in which flicker does not occur in photographing under the light emission of the fluorescent lamp in the 60 Hz region (60 Hz region operation mode), the image sensor control circuit 6 controls the CCD image sensor 4 to perform photographing of the three frames at equal intervals within the synchronous period of ⅕ sec.

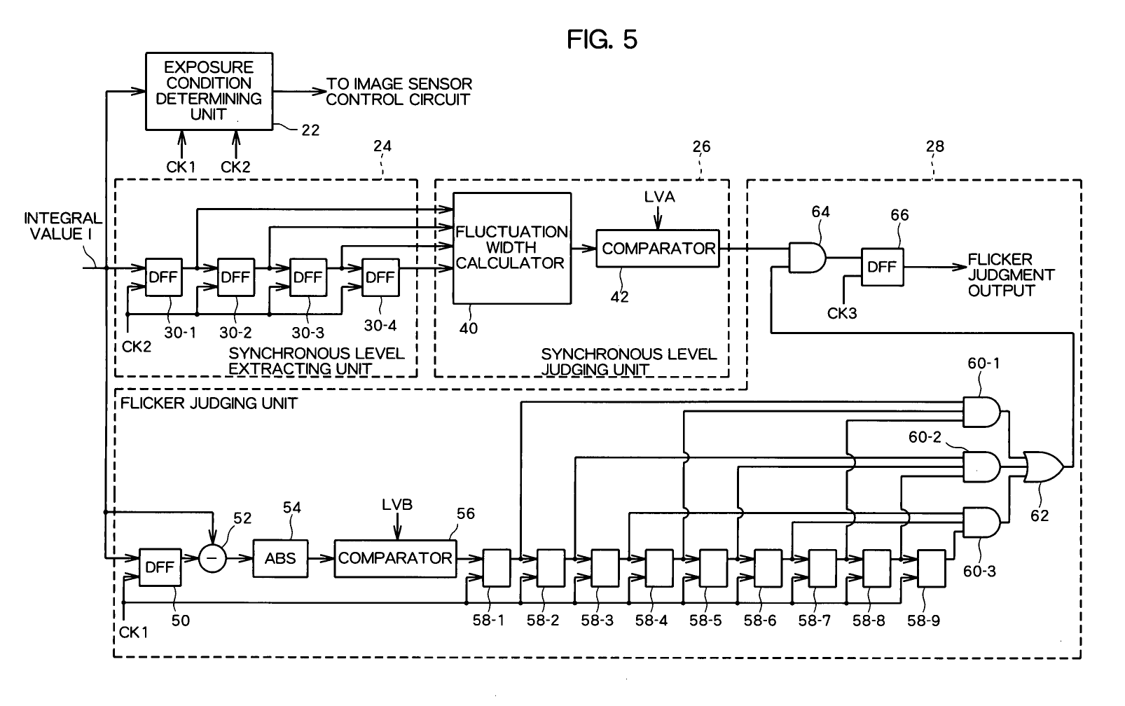

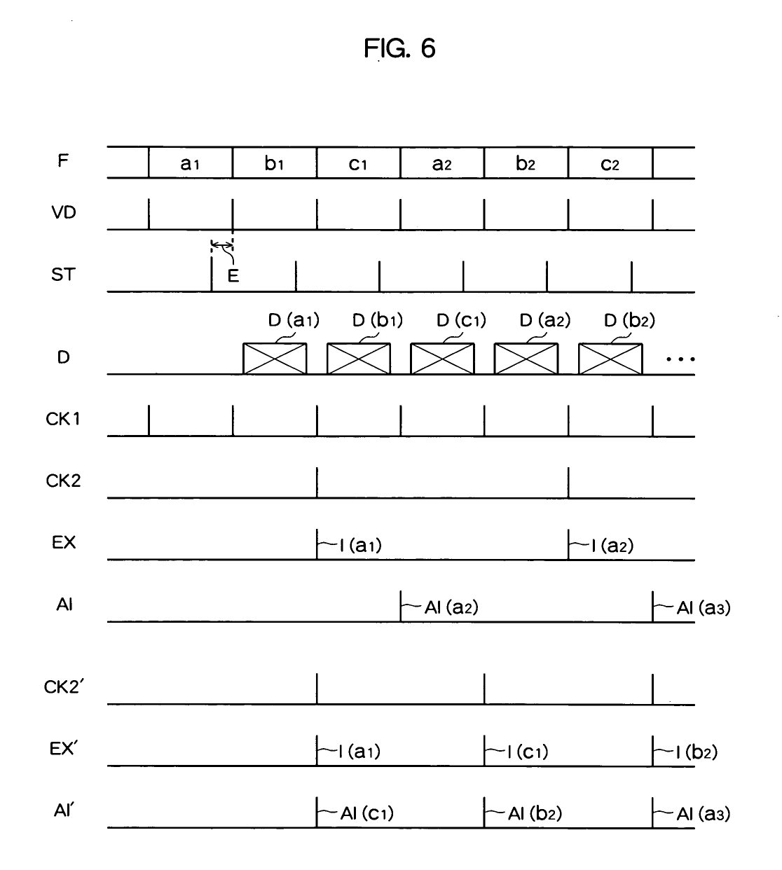

Next, a structure and an operation of a main portion of the flicker detection circuit 20 will be explained. FIG. 5 is a block diagram showing a schematic circuit structure of the flicker detection circuit 20. FIG. 6 is a timing chart for explaining an operation of the flicker detection circuit 20. For convenience of explanation, the flicker detection circuit 20 shown in FIG. 5 is sectioned into an exposure condition determining unit 22, a synchronous level extracting unit 24, a synchronous level judging unit 26, and a flicker judging unit 28. The digital signal processing circuit 12 generates a clock CK1 synchronizing with a vertical synchronizing signal VD of a 1 V period generated by the image sensor control circuit 6 on the basis of the vertical synchronizing signal VD and also generates a clock CK2 by dividing the clock CK1. The clock CK2 defines a feed back period for the auto-iris control. More specifically, when prompt feedback is performed in the auto-iris control, as described in the explanation about the conventional technique, the feedback period is set to two frames. In that case, a period of the clock CK2 is set to two frames. On the other hand, in a flicker detecting operation, which is a characteristic operation of the invention, the synchronous period (⅕ sec) decided from the light-emitting period 1/100 sec in the 50 Hz region, the light-emitting period 1/120 sec in the 60 Hz region, and the frame rate 15 fps is set as feedback periods. In other words, the period of the clock CK2 is set to three frames in the flicker detecting operation.

The digital signal processing circuit 12 calculates an integral value I of an image signal for one screen of each frame on the basis of an image signal data D(n) outputted from the ADC 10 and inputs the integral value I to the flicker detection circuit 20. This integral value I is used in the exposure condition determining unit 22, the synchronous level judging unit 26, and the flicker judging unit 28.

The exposure condition determining unit 22 extracts a value at intervals of a predetermined number of frames of the integral value I, which is inputted at a one frame period, as an image signal level EX and calculates a new exposure condition on the basis of the image signal level EX. For example, the exposure condition determining unit 22 calculates a new control value AI, which is set in the ST register, as an exposure condition and gives the control value AI to the image sensor control circuit 6. A flow of this operation will be explained with reference to FIG. 6. “VD” indicates pulse generation timing of the vertical synchronizing signal VD. In “F”, frames defined in synchronization with VD are represented using the signs a₁, b₁, c₁, a₂, and the like as in FIGS. 2 and 3. In addition, a sign “D(f)” representing image data D means that the data is photographed in a frame f, a sign “I(f)” representing extraction timing of the image signal level EX means that an extracted image signal level is an integral value I (f) based on the data D(f), and a sign “AI(f)” representing timing for outputting the control value AI to the digital signal processing circuit 12 means that an exposure condition for the frame f is updated by the control value.

In the flicker detecting operation, the integration value I of a frame at each synchronous period (three frames), for example, each frame aᵢ(i=1, 2, 3, . . . ) is extracted as the image signal level EX. Therefore, the clock CK2 is generated in synchronization with the clock CK1 that is generated at timing between image data D(aᵢ) and D(bᵢ). The exposure condition determining unit 22 can obtain an integral value I(aᵢ) based on the image data D(aᵢ) as the image signal level EX by performing an extracting operation for the integral value I in synchronization with the clock CK2. The exposure condition determining unit 22 determines a control value AI(aᵢ₊₁), which is an exposure condition defining timing for the shutter trigger ST in a frame aᵢ₊₁ after the synchronous period, on the basis of the obtained I (aᵢ). The exposure condition determining unit 22 obtains timing later than the clock CK2 by one frame on the basis of the clock CK1 such that a control value is updated in the digital signal processing circuit 12 after an exposure period of a frame cᵢ immediately before the frame a_{iα1}. Then, the exposure condition determining unit 22 outputs the control value AI(aᵢ₊₁) to the digital signal processing circuit 12 at the timing.

Incidentally, CK2′, EX′, and AI′ shown in FIG. 6 represent the clock CK2, extraction timing for the image signal level EX, and output timing of the control value AI in usual exposure control for performing feedback at a two-frame period, respectively.

Next, the synchronous level extracting unit 24 will be explained. The synchronous level extracting unit 24 obtains and outputs the image signal level EX at each synchronous period. The synchronous level extracting unit 24 is constituted by connecting delay flip flops (DFF) in series. For example, here, the synchronous level extracting unit 24 is constituted by four stages of DFFs 30 (DFFs 30-1 to 30-4). The respective DFFs 30 output data at an input terminal to an output end in synchronization with the clock CK2. According to the series connection structure, the data outputted at an output end of a k stage becomes input data of a (k+1) stage, and the data is sequentially transmitted to later stages at each period of the clock CK2. The integral value I is inputted to the DFF 30-1 in the first stage. The clock CK2 has a period of three frames in the flicker detecting operation as described above. In addition, here, as shown in FIG. 6, the clock CK2 synchronizes with input timing of the integral value I(aᵢ) of the frame aᵢ. Thus, the DFF 30-1 sequentially captures the integral value I(aᵢ) at intervals of three frames as the image signal level EX in association with the clock CK2. I(aᵢ₊₃), I(aᵢ₊₂), I(aᵢ₊₁), and I(aᵢ) are outputted to output ends of the DFFs 30-1 to 30-4, respectively. The synchronous level extracting unit 24 outputs the image signal levels EX to the synchronous level judging unit 26 at these four timings staggered by three frames from one another.

The synchronous level judging unit 26 is a circuit that judges whether an exposure state is stable on the basis of a fluctuation width of the image signal level EX at each synchronous period. The synchronous level judging unit 26 includes a fluctuation width calculator 40 and a comparator 42. The image signal levels EX at the four timings from the synchronous level extracting unit 24 are inputted to the fluctuation width calculator 40. The fluctuation width calculator 40 calculates and outputs a difference between a maximum value and a minimum value among those four data. The comparator 42 compares an output of the fluctuation width calculator 40 with a reference value LVA. When the fluctuation width of the image signal level EX at each synchronous period is smaller than the reference value LVA, that is, when it is judged that the exposure stable state (synchronous level stable state) is realized, the comparator 42 outputs a voltage signal equivalent to a logical level “H” (High). On the other hand, when the fluctuation width is equal to or larger than the reference value LVA, the comparator 42 outputs a voltage signal equivalent to a logical level “L” (Low). The reference value LVA may be a fixed value or may be set by a user or from an external circuit.

The synchronous level extracting unit 24 and the synchronous level judging unit 26 can judge stability of image signal levels over synchronous period of plural cycles. It is possible to increase the number of stages of the DFFs 30 of the synchronous level extracting unit 24. Stability of image signal levels over a longer period of time is judged by increasing the number of stages. Note that it is preferable to perform this judgment in a state in which gain control in an image signal processing system such as the AGC is not performed.

On the other hand, basically, the flicker judging unit 28 to be described below detects a fluctuation in an image signal level in a synchronous period. The flicker judging unit 28 judges presence or absence of flicker on the basis of the fluctuation. The flicker judging unit 28 includes a DFF 50, a subtracter 52, an absolute value calculator (ABS) 54, a comparator 56, plural DFFs 58, plural AND circuits 60, an OR circuit 62, an AND circuit 64, and a DFF 66. The DFF 50 provided on an input side of the flicker judging unit 28 is given the integral value I as input data and operates in association with the clock CK1. The subtracter 52 is inputted with the directly inputted integral value I and the integral value I delayed by a one-frame period in the DFF 50 and subtracts one from the other to output a difference to the absolute value calculator 54. The absolute value calculator 54 calculates an absolute value of the difference calculated by the subtracter 52 and outputs the absolute value to the comparator 56. The comparator 56 compares a difference of image signal levels between adjacent frames inputted from the absolute value calculator 54 with a reference value LVB. When the difference is larger than the reference value LVB, the comparator 56 outputs a logical level “H”. On the other hand, when the difference is equal to or smaller than the reference value LVB, the comparator 56 outputs a logical level “L”. Note that the reference value LVB may be a fixed value or may be set by a user or from an external circuit.

The DFFs 58 (DFFs 58-1 to 58-9) connected in series in nine stages are provided on an output side of the comparator 56. The number of stages of the DFFs 58 corresponds to a length of a section in which the synchronous level extracting unit 24 extracts the image signal level EX. It is possible to change the number of stages of the DFFs 58 according to the number of stages of the DFFs 30. The respective DFFs 58 are driven in association with the clock CK1 and transmit the 1 bit logical data of “H” or “L” outputted from the comparator 56 to the later stages while delaying the logical data by the one-frame period, respectively. Consequently, data outputted from the comparator 56 at timings staggered by one frame from one another are obtained at output ends of the respective DFFs 58. More specifically, results of comparison by the comparator 56 for |I(aᵢ₊₃)−I(cᵢ₊₂)|, |I(cᵢ₊₂)−I(bᵢ₊₂), |I(bᵢ₊₂)−I(aᵢ₊₂)|, . . . , |I(cᵢ)−I(bᵢ)|, and |I(bᵢ)−I(aᵢ)| are outputted from output ends of the DFFs 58-1 to 58-9, respectively, at timings when I(aᵢ₊₃), I(aᵢ₊₂), I(aᵢ₊₁), and I(aᵢ) are outputted from output ends of the DFFs 30-1 to 30-4.

The logical data “H” or “L” obtained at the output ends of the respective DFFs 58 of nine stages in this way are allotted and inputted to the three AND circuits 60 (AND circuits 60-1 to 60-3). The AND circuits 60 are provided in order to judge whether states of fluctuations in image signal levels at continuous plural synchronous periods coincide with one another, that is, attain coincidence among the states of fluctuations. As it will be understood from a structure to be described below, the number of the AND circuits 60 corresponds to the number of frames of three in the synchronous period. In order to attain the coincidence, the output ends of the DFFs 58 deviating from one another by three stages (i.e., by one cycle of the synchronous period) are connected to input ends of the respective AND circuits 60. More specifically, results of comparison by the comparator 56 for outputs of the DFFs 58-1, 58-4, and 58-7, that is, |I(aᵢ₊₃)−I(cᵢ₊₂)|, |I(aᵢ₊₂)−I(cᵢ₊ₗ)|, and |I(aᵢ₊₁)−I(cᵢ)| are inputted to the AND circuit 60-1. Similarly, results of comparison by the comparator 56 for outputs of the DFFs 58-2, 58-5, and 58-8, that is, |I(cᵢ₊₂)−I(bᵢ₊₂)|, |I(cᵢ₊₁)−I(bᵢ₊₁)|, and |I(cᵢ)−I(bᵢ)| are inputted to the AND circuit 60-2. In addition, results of comparison by the comparator 56 for outputs of the DFFs 58-3, 58-6, and 58-9, that is, |I(bᵢ₊₂)−I(aᵢ₊₂)|, |I(bᵢ₊₁)−I(aᵢ₊)|, and |I(bᵢ)−I(aᵢ)| are inputted to the AND circuit 60-3.

The synchronous period is constituted by three frames, and a difference between adjacent frames is defined for three different timings (phases) in association with the three frames. As it is understood from the specific example described above, the respective, AND circuits 60 are inputted with comparison result data corresponding to a difference between adjacent frames in an identical phase in continuous three synchronous periods, and the three AND circuits 60 judge coincidence in phases different from each other. Outputs of the respective AND circuits 60 are at the “H” level when a fluctuation in an image signal level between adjacent frames in corresponding phases is larger than the reference value LVB at all the three synchronous periods. The outputs are at the “L” level when a fluctuation in an image signal level between adjacent frames is equal to or smaller than the reference value LVB in any one of the synchronous periods. The outputs of the three AND circuits 60 are inputted to the OR circuit 62, and the OR circuit 62 outputs a result of an OR operation to the AND circuit 64.

When a fluctuation in an image signal level between adjacent frames is large at any timing in the synchronous period, it is likely that flicker has occurred. Moreover, when the fluctuation occurs commonly across plural synchronous periods, it is less likely that the fluctuation is caused by an accidental change of a subject. Thus, when an output of the OR circuit 62 is at the “H” level, it is considered to be highly likely that a fluctuation in an image signal level due to flicker has occurred in the synchronous period.

An output of the comparator 42 of the synchronous level judging unit 26 is inputted to the AND circuit 64 together with the output of the OR circuit 62. An output of the AND circuit 64 is inputted to the DFF 66 as input data, and the DFF 66 outputs the input data at timing associated with the clock CK3. This output of the DFF 66 is a result of judgment on flicker by the flicker detection circuit 20. The result at the “H” level means that occurrence of flicker has been detected. On the other hand, the result at the “L” level means that flicker has not occurred. In other words, even if an image signal level fluctuates in the synchronous period, the flicker detection circuit 20 does not judge that flicker has occurred unless it is judged in the synchronous level extracting unit 24 and the synchronous level judging unit 26 that the exposure stable state, in which the image signal level EX at each synchronous period is maintained within the predetermined range, is realized. This is because, since a situation in which the exposure stable state is not realized is, for example, a case in which a luminance change occurs due to movement or the like of a subject, it is highly likely that judgment of occurrence of flicker based on a fluctuation of an image signal level in the synchronous period in such a situation leads to misdetection. From that viewpoint, it is possible to constitute the flicker detection circuit 20 such that an output of the comparator 42 and an output of the OR circuit 62 are independent from each other and the flicker detection circuit 20 can provide three kinds of judgment results, that is, “flicker judgment is impossible” when the output of the comparator 42 is “L”, “flicker occurred” when the output of the comparator 42 is “H” and the output of the OR circuit 62 is “H”, and “no flicker” when the output of the comparator 42 is “H” and the output of the OR circuit 62 is “L”.

Note that the clock CK3 is provided for correcting a processing time difference between the respective circuit systems giving two inputs to the AND circuit 64, that is, a circuit of the synchronous level extracting unit 24 and the synchronous level judging unit 26 and a circuit from the DFF 50 to the OR circuit 62 of the flicker judging unit 28. These two systems apply calculations to an identical frame section as explained above, and the AND circuit 64 compares results of the calculations. When there is a processing time difference between both the systems, results of judgment by the two systems inputted to the AND circuit 64 could be based on different frame sections. Thus, an output of a final result of judgment from the flicker detection circuit 20 is suspended by the DFF 66 and the clock CK 3 until the results of judgment by the two systems given to the AND circuit 64 change to be based on an identical frame section.

When the flicker detection circuit 20 detects flicker, control for switching the driving of the CCD image sensor 4 is performed. For example, the digital signal processing circuit 12 holds a state, which indicates whether the image sensor control circuit 6 currently drives the CCD image sensor 4 in the 50 Hz region operation mode or in the 60 Hz region operation mode, in a flag or the like. When the flicker detection circuit 20 detects flicker, the digital signal processing circuit 12 instructs the image sensor control circuit 6 to drive the CCD image sensor 4 in the other operation mode different from the current operation mode.

For example, the judging operation by the flicker detection circuit 20 may be performed automatically at the time of startup of the image pickup apparatus 2 or may be performed on the basis of operation by a user. In addition, an operation mode, which is set once on the basis of a result of the judgment, may be held even if a power supply of the image pickup apparatus 2 is turned off.

In the structure described above, the flicker judging unit 28 calculates a difference of image signal levels between adjacent frames and judges a fluctuation in an image signal level between the frames on the basis of an absolute value of the difference. Instead, it is possible that the flicker judging unit 28 calculates a ratio of image signal levels of adjacent frames and judges a fluctuation in an image signal level on the basis of whether the ratio is within a predetermined range with 1 as a center value.

In the structure described above, the flicker detection circuit 20 measures an exposure state at each synchronous period and subjects the exposure condition to feedback control on the one hand and judges whether the exposure state is stable on the basis of a result of the measurement on the other hand. Then, the flicker detection circuit 20 regards the result of the judgment on flicker as effective only when the exposure stable state is realized and improves reliability of the flicker detection. However, this effect of the improvement of reliability may be obtained even if both the exposure control at the synchronous period and the judgment on the exposure stable state are not always performed.

As an example of such a case, the flicker detecting operation is performed with the image pickup apparatus pointed at a subject that does not change basically. Under such a situation, it can be expected that exposure control at each synchronous period is performed suitably, and it is not unreasonable to estimate that the exposure state measured at each synchronous period is within a predetermined range and in a stable state. Thus, the flicker detecting device, in which only the exposure control is performed and the judgment on the exposure stable state is omitted, that is, the synchronous level extracting unit 24 and the synchronous level judging unit 26 are removed, may be mounted on the image pickup apparatus. In addition, under the same situation, the exposure stable state could be realized even if the exposure control is not performed. Thus, reliability of the flicker detection could be improved even if the exposure control is stopped and only the judgment on the exposure stable state is performed.

In the structure described above, the flicker detection circuit 20 extracts fluctuation widths I(aᵢ₊₃), I(aᵢ₊₂), I(aᵢ₊₁), and I(aᵢ) from the integral value I measured for each frame in the synchronous level extracting unit 24 and judges the exposure stable state on the basis of those fluctuation widths. However, the flicker detection circuit 20 may extract the image signal level EX at each synchronous period from the integral value I measured for each frame by changing phases and judge the exposure stable state for the plural phases. For example, two circuits, which are the same as the circuit of the synchronous level extracting unit 24 and the synchronous level judging unit 26, are further provided in parallel. The synchronous level extracting unit 24 of one of the circuits extracts an image signal level at a clock of a phase delayed by one frame with respect to the clock CK2 (a period of the clock is three frames as in the clock CK2). The synchronous level extracting unit 24 of the other of the circuits extracts an image signal level at a clock of a phase delayed by two frames with respect to the clock CK2 (a period of the clock is three frames as in the clock CK2). It is possible to judge the exposure stale state base on fluctuation widths I(bᵢ₊₃), I(bᵢ₊₂), I(bᵢ₊₁), and I(bᵢ) and the exposure stable state based on fluctuation widths I(cᵢ₊₃), I(cᵢ₊₂), I(cᵢ₊₁), and I(cᵢ). Then, for example, the flicker detection circuit 20 may make a result of judgment by the flicker judging unit 28 effective only when the exposure stable state is realized in all the phases or make a result of judgment by the flicker judging unit 28 effective when the exposure stable state is realized in two or more phases.

In the structure described above, the synchronous period is set to a common multiple of 1/f1, 1/f2, and 1/fp (here, ⅕ sec) in order to make it possible to detect flicker in photographing at the frame rate fp (here, 15 fps) accurately anywhere in the regions of two types of AC power supply frequencies f1 and f2 (here, 50 Hz and 60 Hz). However, it is possible to use the invention without regard to the number of types of AC power supply frequencies. For example, if three types of frequencies f1, f2, and f3 could be present as a region where the image pickup apparatus is used, a synchronous frequency only has to be set to a common multiple of 1/f1, 1/f2, 1/f3, and 1/fp. If the region where the image pickup apparatus is used is limited to the region of the one kind of frequency f1, the synchronous frequency only has to be set to a common multiple of 1/f1 and 1/fp.

1. A flicker detecting device that is used in an image pickup apparatus for photographing an image at a frame rate fp and detects flicker of an image due to a light source, brightness of which changes periodically at a period of 1/f, the flicker detecting device comprising:
a synchronous level extracting unit that extracts a synchronous image signal level on the basis of the image photographed at each synchronous period that is a common multiple of 1/f and 1/fp;
an exposure control unit that performs exposure control for maintaining photographing by the image pickup apparatus in a predetermined exposure state on the basis of the synchronous image signal level; and
a flicker judging unit that detects a fluctuation in an image signal level in the synchronous period of the image and judges presence or absence of the flicker on the basis of the level fluctuation.

2. A flicker detecting device according to claim 1, further comprising a synchronous level judging unit that judges whether a synchronous level stable state, in which the synchronous image signal level is maintained within a predetermined range, is realized, wherein
the flicker judging unit makes a result of the judgment on presence or absence of the flicker effective when the synchronous level stable state is realized.

3. A flicker detecting device according to claim 1, wherein
when a degree of the fluctuation is larger than a predetermined reference value, the flicker judging unit judges that the flicker has occurred.

4. A flicker detecting device according to claim 1, wherein
when a degree of the fluctuation is larger than a predetermined reference value in each of a predetermined number of continuous synchronous periods, the flicker judging unit judges that the flicker has occurred.

5. A flicker detecting device that is used in an image pickup apparatus for photographing an image at a frame rate fp and detects flicker of an image due to a first light source, brightness of which changes periodically at a period of 1/f1, and flicker of an image due to a second light source, brightness of which changes periodically at a period of 1/f2, the flicker detecting device comprising:
a synchronous level extracting unit that extracts a synchronous image signal level on the basis of the image photographed at each synchronous period that is a common multiple of 1/f1, 1/f2, and 1/fp;
an exposure control unit that performs exposure control for maintaining photographing by the image pickup apparatus in a predetermined exposure state on the basis of the synchronous image signal level; and
a flicker judging unit that detects a fluctuation in an image signal level in the synchronous period of the image and judges presence or absence of the flicker on the basis of the level fluctuation.

6. A flicker detecting device according to claim 5, further comprising a synchronous level judging unit that judges whether a synchronous level stable state, in which the synchronous image signal level is maintained within a predetermined range, is realized, wherein
the flicker judging unit makes a result of the judgment on presence or absence of the flicker effective when the synchronous level stable state is realized.

7. A flicker detecting device according to claim 5, wherein
when a degree of the fluctuation is larger than a predetermined reference value, the flicker judging unit judges that the flicker has occurred.

8. A flicker detecting device according to claim 5, wherein
when a degree of the fluctuation is larger than a predetermined reference value in each of a predetermined number of continuous synchronous periods, the flicker judging unit judges that the flicker has occurred.

9. A flicker detecting device that is used in an image pickup apparatus for photographing an image at a frame rate fp and detects flicker of an image due to a light source, brightness of which changes periodically at a period of 1/f, the flicker detecting device comprising:
a synchronous level extracting unit that extracts a synchronous image signal level on the basis of the image photographed at each synchronous period that is a common multiple of 1/f and 1/fp;
a synchronous level judging unit that judges whether a synchronous level stable state, in which the synchronous image signal level is maintained within a predetermined range, is realized; and
a flicker judging unit that detects a fluctuation in an image signal level in the synchronous period of the image and judges presence or absence of the flicker on the basis of the level fluctuation, wherein
the flicker judging unit makes a result of the judgment on presence or absence of the flicker effective when the synchronous level stable state is realized.

10. A flicker detecting device according to claim 9, wherein
when a degree of the fluctuation is larger than a predetermined reference value, the flicker judging unit judges that the flicker has occurred.

11. A flicker detecting device according to claim 9, wherein
when a degree of the fluctuation is larger than a predetermined reference value in each of a predetermined number of continuous synchronous periods, the flicker judging unit judges that the flicker has occurred.

12. A flicker detecting device that is used in an image pickup apparatus for photographing an image at a frame rate fp and detects flicker of an image due to a first light source, brightness of which changes periodically at a period of 1/f1, and flicker of an image due to a second light source, brightness of which changes periodically at a period of 1/f2, the flicker detecting device comprising:
a synchronous level extracting unit that extracts a synchronous image signal level on the basis of the image photographed at each synchronous period that is a common multiple of 1/f1, 1/f2, and 1/fp;
a synchronous level judging unit that judges whether a synchronous level stable state, in which the synchronous image signal level is maintained within a predetermined range, is realized; and
a flicker judging unit that detects a fluctuation in an image signal level in the synchronous period of the image and judges presence or absence of the flicker on the basis of the level fluctuation, wherein
the flicker judging unit makes a result of the judgment on presence or absence of the flicker effective when the synchronous level stable state is realized.

13. A flicker detecting device according to claim 12, wherein
when a degree of the fluctuation is larger than a predetermined reference value, the flicker judging unit judges that the flicker has occurred.

14. A flicker detecting device according to claim 12, wherein
when a degree of the fluctuation is larger than a predetermined reference value in each of a predetermined number of continuous synchronous periods, the flicker judging unit judges that the flicker has occurred.

15. An image pickup apparatus for photographing an image at a frame rate fp that is capable of switching at least a drive state in which flicker of an image does not occur under a first light source, brightness of which changes periodically at a period of 1/f1, and a drive state in which flicker of an image does not occur under a second light source, brightness of which changes periodically at a period of 1/f2, the image pickup apparatus comprising:
a synchronous level extracting unit that extracts a synchronous image signal level on the basis of the image photographed at each synchronous period that is a common multiple of 1/f1, 1/f2, and 1/fp;
an exposure control unit that performs exposure control for maintaining the photographing by the image pickup apparatus in a predetermined exposure state on the basis of the synchronous image signal level;
a flicker judging unit that detects a fluctuation in an image signal level in the synchronous period of the image and judges presence or absence of the flicker on the basis of the level fluctuation; and
a switching unit that switches the drive states according to a result of the judgment of the flicker judging unit.

16. An image pickup apparatus according to claim 15, further comprising a synchronous level judging unit that judges whether a synchronous level stable state, in which the synchronous image signal level is maintained within a predetermined range, is realized, wherein
the flicker judging unit makes a result of the judgment on presence or absence of the flicker effective when the synchronous level stable state is realized.

17. An image pickup apparatus according to claim 16, wherein
when the flicker is detected, the switching unit switches a present drive state to another drive state in which the flicker does not occur.

18. An image pickup apparatus for photographing an image at a frame rate fp that is capable of switching at least a drive state in which flicker of an image does not occur under a first light source, brightness of which changes periodically at a period of 1/f1, and a drive state in which flicker of an image does not occur under a second light source, brightness of which changes periodically at a period of 1/f2, the image pickup apparatus comprising:
a synchronous level extracting unit that extracts a synchronous image signal level on the basis of the image photographed at each synchronous period that is a common multiple of 1/f1, 1/f2, and 1/fp;
a synchronous level judging unit that judges whether a synchronous level stable state, in which the synchronous image signal level is maintained within a predetermined range, is realized;
a flicker judging unit that detects a fluctuation in an image signal level in the synchronous period of the image and judges presence or absence of the flicker on the basis of the level fluctuation; and
a switching unit that switches the drive states according to a result of the judgment of the flicker judging unit, wherein
the flicker judging unit makes a result of the judgment on presence or absence of the flicker effective when the synchronous level stable state is realized.

19. An image pickup apparatus according to claim 18, wherein
when the flicker is detected, the switching unit switches a present drive state to another drive state in which the flicker does not occur.
